(19) United States
(12) Patent Application Publication
(10) Pub. No.: US 2011/0256348 A1
(43) Pub. Date: Oct. 20, 2011

(54) METHOD FOR FORMING A WOOD COMPOSITE PRODUCT, A WOOD COMPOSITE PRODUCT, AND AN APPARATUS FOR THE MANUFACTURE OF A WOOD COMPOSITE PRODUCT

(75) Inventors: Markku Koivisto, Kauniainen (FI); Jari Nisula, Lahti (FI); Sami Kirvesoja, Hollola (FR); Liisa Lehtinen, Lahti (FI)

(73) Assignee: UPM-KYMMENE CORPORATION, Helsinki (FI)

(21) Appl. No.: 13/126,953

(22) PCT Filed: Oct. 30, 2009
(86) PCT No.: PCT/FI2009/050877

§ 371 Date: Jun. 28, 2011

(30) Foreign Application Priority Data
Oct. 31, 2008 (FI) 20086033

(51) Int. Cl. B32B 21/02; B29C 47/92

(52) U.S. Cl. 428/146; 264/40.6

(57) ABSTRACT

A method for forming a wood composite product by extrusion with a manufacturing apparatus. The temperature profile prevailing in the manufacturing apparatus is adjusted in such a way that the surface of the wood composite product to be formed becomes rough. A wood composite product and an apparatus for manufacturing a wood composite product.

### FIELD OF THE INVENTION

The invention relates to wood composite products, such as patio planks of wood composite.

### BACKGROUND OF THE INVENTION

In extrusion methods, plastic raw material is melted and blended with possible additives and colouring agents and is extruded through a die having a given profile to form a product. When passing through the die, the product obtains its final or nearly final shape. From the die, the product is typically led into a calibration unit, in which it obtains the precise final dimensions. After this, the product is led further to cooling. The product is sawed into a desired length on the production line. Normally, the raw material is fed in granulate or powder form into the extruder.

Wood plastic composites made by the extrusion method are made by adding a wood-based material as filler, and various processing auxiliary agents, to the matrix plastic. The wood-based materials used are typically sawdust, but they may also consist of chips or chemical pulp fibre.

In known methods for manufacturing wood plastic composite, a profile with a smooth surface is formed. The friction properties of the surface can be improved by forming grooves on the surface. The friction properties of the surface can also be improved by roughening the surface of the product with a metal brush after the extrusion. Thus, the surface of the product is depleted of the plastic layer that makes the surface slippery, particularly when wet. When the plastic layer is removed, the wood fibres are exposed and thereby subjected to UV radiation, moisture and dirt. As a result of the depletion of the plastic layer, water absorption is also increased, which, in turn, impairs the mechanical properties of the structure, increases the risk of mould growth, and affects the dimensions. Furthermore, the possible colouring agent is removed from the surface. The plastic layer to be removed may also contain a UV protection, wherein the roughening accelerates the aging of the product.

### BRIEF SUMMARY OF THE INVENTION

It is an aim of the invention to present a solution to improve the friction properties of the surface of a wood composite product.

To attain this purpose, the method according to the invention is primarily characterized in what will be presented in the independent claim 1. The product according to the invention, in turn, is primarily characterized in what will be presented in the independent claim 11. The apparatus for manufacturing a wood composite product according to the invention, in turn, is primarily characterized in what will be presented in the independent claim 16. The other, dependent claims will present some preferred embodiments of the invention.

The basic idea of the invention is that the surface of a composite product formed by an extruder is made rough already in the production process; in other words, its surface is provided with bulges and depressions, which are not smoothed or polished later in the process, wherein the surface has a high friction. The aim is thus to make the surface as matt and rough as possible already in the production process, wherein the surface of the product does not need to be finished, for example brushed to become rough.

In the invention, an unwanted phenomenon in extrusion is utilized in a surprising manner. In extrusion, the aim is conventionally to make the surface of the product as smooth as possible. In the invention, however, a rough surface is formed, which can be obtained by such a controlled melt fracture phenomenon which might be classified as an unwanted flow defect in conventional solutions. A difference to extrusion methods of prior art is, among other things, the different temperature profile of the manufacturing apparatus.

According to the basic idea, the surface of the wood composite product is formed to have a predetermined roughness by utilizing the melt fracture that is known by persons skilled in the art of plastics and is obtained by a setting of the temperature profile of the manufacturing apparatus. The temperature profile of the manufacturing apparatus is set to be such that the temperatures of the manufacturing apparatus and the wood composite material flowing in the apparatus are unbalanced with respect to each other. This means that the temperature of the mass is kept slightly too high and the temperature of the manufacturing apparatus slightly too low; as a result, a melt fracture defect arises on the surface of the product, and the desired rough surface is obtained. In an advantageous embodiment, the melt fracture defect occurs only in the surface layer of the product.

In the method according to the basic idea, the surface of the wood composite product is made rough, the roughness being achieved by adjusting the temperature profile prevailing in the manufacturing apparatus in such a way that the temperature is higher at the initial end of the extruder than at the terminal end of the extruder, and the temperature is higher in the die than at the terminal end of the extruder.

In an embodiment, the temperature of the material to be fed into the die is 165 to 185° C.

In an embodiment, a calibration device is used to produce an underpressure of 14 to 40 kPa (0.1 to 0.4 bar) effective on the material.

In one embodiment, material is fed by the feed screw of the extruder at a pressure of 8.5 to 9.5 MPa (85 to 95 bar).

The surface of the wood composite product according to the basic idea is a uniform rough surface formed by extrusion. In an embodiment, the bulges and depressions on the surface form a regular rough pattern or “shark skin”. In an advantageous embodiment, the deviation of the bulges and depressions on the surface is less than 1 mm. In some embodiments, the deviation may be 10 to 700 μm.

The apparatus for manufacturing a wood composite structure according to the basic idea comprises at least one or more extruders, a die, and a calibration device, as well as heating devices for heating the composite material. The heating devices are arranged to heat the composite material in such a way that the surface of the forming wood composite product becomes rough. In an advantageous embodiment, the heating devices are arranged to heat the composite material entering the die to the temperature of 165 to 185° C. In an advantageous embodiment, the calibration device comprises underpressure generating means for forming an underpressure of 10 to 40 kPa.

In an embodiment, the product is formed of adhesive label laminate and polymer material. In an advantageous embodiment, the adhesive label laminate consists of shredded adhesive label laminate waste. In an embodiment, the adhesive label laminate waste consists of label material covered with an adhesive layer, and on top of the adhesive layer, release material is provided as protective paper for the adhesive layer, to be easily released in the use. In an advantageous embodiment, the label material and/or the release material comprises a wood fibre based component and/or a plastic or polymer based or other organic component. It is also possible to use various inorganic substances. In an embodiment, the label and/or release material is wood-fibre based paper, cardboard or the like. In an embodiment, the wood-fibre based paper, cardboard or the like contains or has been treated with a plastic or polymer based material. In an embodiment, the adhesive and/or release material may consist of a substantially plastic or polymer based material. In an embodiment, the release material contains a silicon-based component. The release material is preferably siliconized.

Various advantages are achieved with the different embodiments of the invention. First of all, the product, such as a patio plank, has so high a friction coefficient that it is not slippery, even when wet.

The roughness of the surface is achieved by providing the shark skin onto the surface of the product in a controlled manner by the melt fracture phenomenon. In this way, the surface of the plank will not require subsequent brushing, which is typically applied to make a composite product non-slip. Advantages of the method to brushing include good colour durability, durability of weatherproofness, lower water absorption, higher resistance to mould and dirt, as well as the avoidance of subsequent processing.

### DESCRIPTION OF THE DRAWINGS

In the following, the invention will be described in more detail with reference to the appended principle drawings, in which

FIG. 1 illustrates the principle of the assembly of the apparatus;

FIG. 2 illustrates the principle of a detail in an embodiment of the apparatus;

FIG. 3 illustrates another embodiment of the apparatus;

FIG. 4 shows a cross-sectional view of a wood composite product;

FIG. 5 illustrates the temperature profiles in both an apparatus for manufacturing a wood plastic composite according to the invention and an apparatus for manufacturing a wood plastic composite according to the prior art.

For the sake of clarity, the drawings only show the details necessary for understanding the invention. The structures and details that are not necessary for understanding the invention but are obvious for anyone skilled in the art have been omitted in the figures in order to emphasize the characteristics of the invention. Furthermore, the dimensions of the figures do not necessarily correspond to the reality, but the aim in the figures is to illustrate the principle of the solution by selecting the dimensions in a way that is appropriate for the representation.

### DETAILED DESCRIPTION OF THE INVENTION

In the example, an apparatus is used, into which shredded adhesive label laminate and plastic are fed, as well as possible additives, such as colouring agents and adhesion promoters.

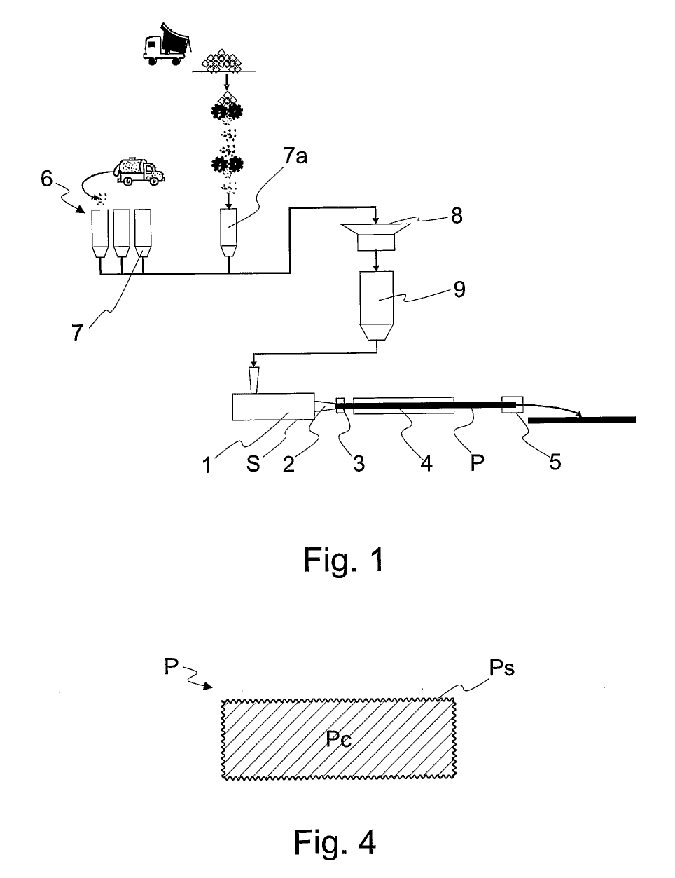

FIG. 1 shows an apparatus for manufacturing a wood composite structure, and its connection to material flows. The apparatus according to the example comprises an extruder 1, a shaping unit 2, that is, a die, a calibration unit 3, a cooling unit 4, a cutting unit 5, as well as a material feeding unit 6. In the figure, the material feeding unit 6 comprises material silos 7 for the different components, such as colouring agents and other additives. Additional plastic can also be admixed with the material from the silo 7. Furthermore, the figure shows a separate silo 7a for adhesive label laminate, into which silo the adhesive label laminate material is led via shredders. From the silos 7 and 7a, the material is led into a mixing unit 8. From here, the material can be led further into an intermediate storage 9 or to subsequent blending before leading it into the extruder 1.

The cooling unit 4 is arranged to cool the finished product P. In this apparatus, the cooling is done with water.

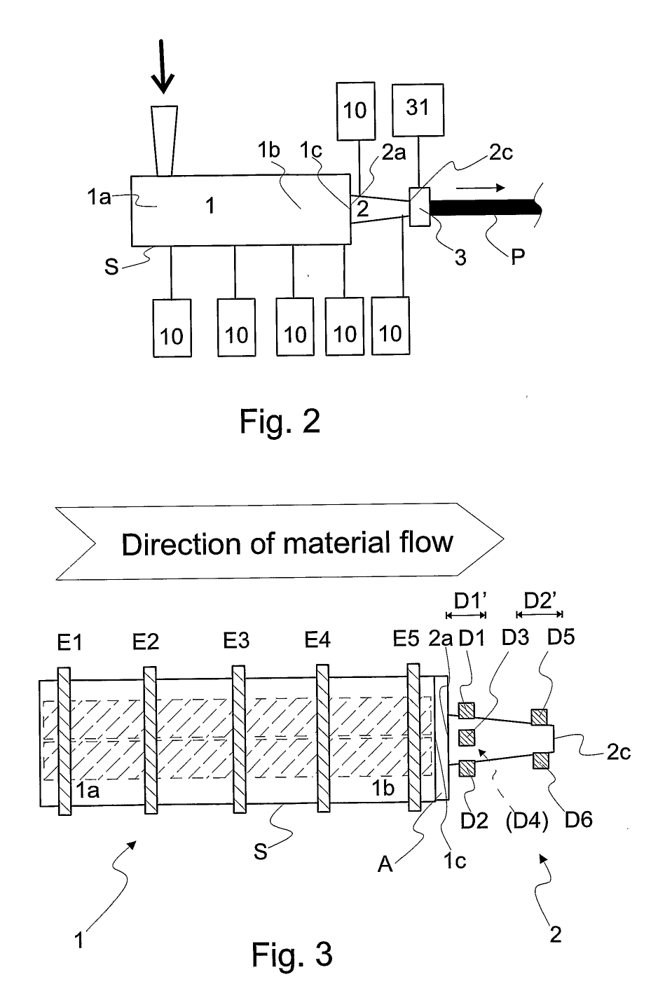

The apparatus of FIG. 2 comprises a twin screw extruder device 1, into which the material mixture is led from the mixing unit 8 (not shown in FIG. 2). A die 2 and a calibration unit 3 are provided in connection with the extruder 1.

The screw unit of the extruder (twin-screw extruder) 1 comprises two screws (not shown in the figure) which convey the material further inside a cylinder S. The cylinder S surrounding the screws is heated. The rotation of the screws in the screw unit 1 also produces heat. Preferably, the temperature of the cylinder S of the twin-screw extruder 1 is separately adjustable at different points of the twin-screw extruder. For example, the cylinder S of the twin-screw extruder 1 may be divided into 2 to 8 zones in the feeding direction, the temperatures of the zones being separately adjustable. For the heating, suitable heating devices 10 can be used, such as, for example, resistors, heating elements, etc. Preferably, the temperature profile of the extruder 1 is adjusted to be steep; seen from the direction of the material flow, the temperature at the initial end 1a of the extruder is high and the temperature at the terminal end 1b of the extruder is as low as possible. In an advantageous embodiment, the initial temperature of the initial end 1a of the extruder is adjusted to 200 to 235° C. The relatively high temperature makes it possible to use very stiff additional plastic. At the terminal end 1b of the extruder, before an adapter A, the temperature is 140 to 150° C., and in the adapter A, it is slightly higher, for example about 170° C. The temperatures used are affected, among other things, by the material to be extruded, the feeding pressure, and the rotation speed of the screws. In the example, a mixture of adhesive label laminate and plastic is driven through the extruder 1, the pressure of the blend being about 85 to 95 bar (8.5 to 9.5 MPa) in the extruder.

The die is also divided into different zones, whose temperatures can be adjusted separately. Suitable heating devices 10 are used for heating. The temperature of the inlet 2a of the die 2 is adjusted preferably to about 180 to 190° C. The temperature of the outlet 2c of the die 2 is adjusted higher, for example to about 195 to 205° C. For the adjustment, the apparatus is naturally also provided with temperature measurement sensors and control and adjustment devices, which are, for clarity, not shown in the figures.

FIG. 3 shows, in a principle view, the assembly of an extruder 1 and a die 2 for the apparatus, and the heating devices used for adjusting the temperature profile of the manufacturing apparatus. In the example, the cylinder of the extruder 1 comprises five heating zones E1, E2, E3, E4, and E5. The heating zones are arranged in the extruder in such a way that El is, in the direction of material flow, the first heating zone at the initial end of the extruder, and E5 is the last heating zone at the terminal end of the extruder. The heating zones E1 to E5 comprise at least one adjustable heating resistor each. Furthermore, it is possible to adjust the temperature of the adapter A that is connected to the extruder and connects the extruder and the die. In an embodiment, the temperature of the first heating zone E1 is 225 to 235° C., preferably 230° C., the temperature of the second heating zone E2 is 220 to 230° C., preferably 225° C., the temperature of the third heating zone E3 is 210 to 220° C., preferably 215° C., the temperature of the fourth heating zone E4 is 170 to 180° C., preferably 175° C., and the temperature of the fifth heating zone E5 is 140 to 150° C., preferably 145° C. The temperature of the adapter A, that is, the sixth heating zone, is 165 to 175° C., preferably 170° C.

In an embodiment, the aim is to use the first two heating zones E1, E2 to raise the temperature of the material fed into the extruder so high that the moisture of the material can be evaporated and removed before the next zones.

In the example, the die 2 comprises two heating zones D1′ and D2′, having a total of six heating devices D1 to D6. The heating zone D1′ of the die is arranged, in the direction of material flow, at the initial end of the die, which initial end is connected to the adapter A, and the heating zone D2′ of the die is arranged at the terminal end of the die. The four heating zones D1 to D4 are placed, in the direction of the material flow, substantially at the same location along the length of the die and at regular intervals with respect to the perimeter of the die. In this example, the first heating device D1 is placed above the die 2, the second heating device D2 underneath the same, the third heating device D3 on a first side of the die, and the fourth heating device D4 on its second side. The fifth and sixth heating devices D5, D6 are placed, in the direction of material flow, substantially after the preceding ones in such a way that the fifth heating device D5 is above the die 2 and the sixth heating device D6 underneath the same. The heating devices D1 to D6 are adjusted to heat the die in such a way that the temperature of the first heating zone D1′ is 180 to 190° C., preferably 185° C., and the temperature of the second heating zone D2′ is 195 to 205° C., preferably 200° C. When entering the die 2, that is, in the adapter A, the mass has a surface temperature of about 165 to 185° C., preferably 170 to 180° C. The inner temperature of the mass is about 5 to 15° C. higher than the surface temperature. In an advantageous embodiment, the primary temperature of the die 2, that is, the temperature of the zone D1′, is lower than the temperature of the mass. In the example, the production rate is about 400 kg/h.

One or more heating zones E1 to E5, A, D1′ and D2′ can also be cooled, if necessary. For cooling, it is possible to use, for example, air cooling. In an advantageous embodiment, the temperatures of the heating zones of the extruder 1 and the die 2 are: E1 230° C.; E2 225° C.; E3 215° C.; E4 175° C.; E5 145° C.; A 170° C.; D1′ 185° C. and D2′ 200° C. The temperature of the mass before the die is about 170 to 180° C.

As learned from the above description, the control of the temperatures in the manufacturing process is very important to obtain a product of the exactly right kind, that is, having a rough surface.

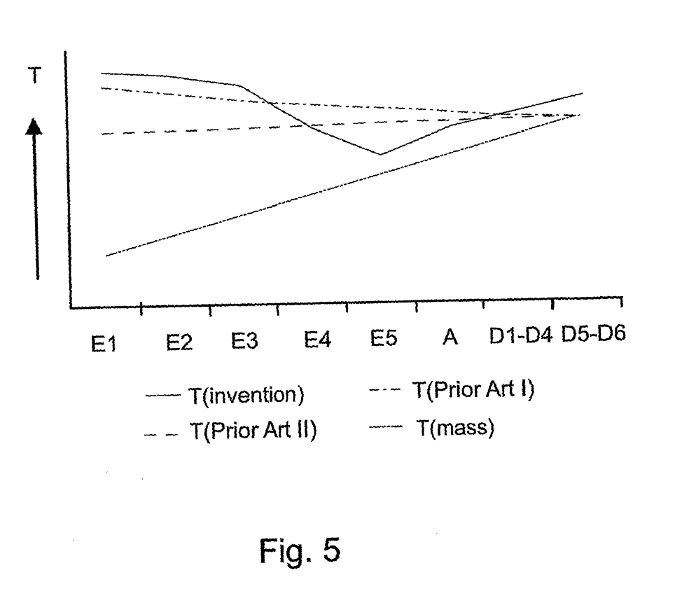

In the following, the difference between the invention and the prior art will be described with reference to FIG. 5, which shows schematically the temperature profiles in both the apparatus according to the invention and an apparatus according to the prior art for manufacturing a wood plastic composite. The vertical axis of the diagram represents the temperature that rises from below upwards. The horizontal axis represents the different parts of the manufacturing apparatus in the direction of mass flow.

The curves Prior Art I and Prior Art II show examples of temperature profiles used in manufacturing methods of prior art. In these methods, the aim is to obtain a wood plastic composite product with a completely smooth surface. As seen from the curves, in the method of Prior Art I, the temperature of the manufacturing apparatus is decreased evenly through the whole manufacturing process. In the method of Prior Art II, the temperature at the initial end of the manufacturing apparatus is slightly lower than in the method of Prior Art I, and it is raised slowly through the whole process so that at the end, the temperature is the same as in the method of Prior Art I. The temperature profiles are thus even, and they have no deviations.

As seen from the diagram, the temperature profile used in the manufacturing method according to the invention is completely different from the temperature profiles of prior art. The curve T (invention) indicates the temperature profile of the manufacturing apparatus according to the invention. At the initial end of the extruder, the temperature is high, considerably higher than in the methods of prior art. The aim is to make the plastic material melt fast. At the same time when the screws convey the material forward in the extruder, they blend it and simultaneously also heat it by the frictional heat generated by their rotation. At the terminal end of the extruder, the temperature decreases until it is raised again in the adapter A and in the die 2. In the die 2, the temperature is lower at the inlet 2a than at the outlet 2c of the die. With this kind of a temperature profile, melt fractures are obtained in a controlled manner on the surface of the wood plastic composite product, and the result is a wood plastic composite product having a surface with a predetermined roughness when it exits the manufacturing apparatus.

As disclosed above, the heating of the extruder takes place not only by means of the heating resistors arranged in the different heating zones but also by means of frictional heat produced by the screws. The heating resistors and/or coolers placed in the zones are used for the final adjustment of the temperatures. At the initial end of the extruder, in the range of action of the heating zones E1 and E2, the respective at least one heating resistor effective on the zone is adjusted to achieve a high temperature. The respective at least one heating resistor effective on the heating zone E3 is adjusted so that the temperature of the apparatus decreases to some extent. At the terminal end of the extruder, in the range of action of the heating zones E4 and E5, at least one heating resistor is adjusted so that the temperature of the apparatus decreases further, now more steeply. The respective at least one heating resistor effective on the temperature of the adapter A is adjusted so that the temperature of the apparatus rises again, and the heating means effective on the temperature of the die in the zones D1′ and D2′ are also adjusted so that the temperature rises again.

It is essential for the invention that the temperature profile of at least the die 2 in the direction of material flow is adjusted so that the temperatures of the die 2 and the material are slightly unbalanced, that is, they are not the same. In this way, a suitable friction is obtained on the inner surface of the die 2, and the fluent slipping of the mass on the inner surface of the die is prevented. Thus, the surface of the product is “broken” when it exits the die, and a rough surface is obtained.

The outlet temperature of the product coming out of the die will depend on the rotation speed of the screws of the extruder 1 and on the temperature profile of the cylinder as well as the temperature of the die 2. Preferably, the surface temperature of the mass flowing inside the die is adjusted to be higher than the temperature of the die.

From the die 2, the formed product P is led into a calibration unit 3, in which an underpressure prevails and which is preferably directly connected with the die. The underpressure of the calibration unit 3, that is, the pressure at which the surface of the product 3 is sucked against the surface of the calibration unit, is 0.1 to 0.4 bar. The pressure is generated with a suitable underpressure generating means 31, such as, for example, a pump. The pressure is lower than in the solutions of prior art, and preferably the magnitude of the pressure varies in different parts of the calibration unit. By using a low underpressure, excessive smoothing of the surface of the product P is prevented, and a rough surface is obtained for the final product. By adjusting the pressure, it is also possible to affect the roughness of the surface. For example, in an embodiment, the deviation of the bulges and depressions on the surface of the product coming out of the die 2 is more than 1 mm from the average surface. With the calibration unit 3, the magnitude of the roughness can be limited to about 1 mm. Preferably, the roughness of the surface, that is, the deviation of the bulges and depressions on the surface from the primary level of the surface, is 10 to 700 μm.

The wood composite product P coming out of the calibration device 3 comprises a core P_{c} and a surface layer Pₛ, which are formed simultaneously. FIG. 4 shows a formed wood composite product P in a cross-sectional view. In the example, the product is a patio plank. It is also possible to form other patterns, such as various grooves, on the product P. The product may also be solid, or it may have channels inside it. The shape of the product P is affected with the die 2.

Intensified cooling of the wood composite product is also started in the calibration unit 3 according to the example. The calibration unit 3 is cooled. The cooling can be implemented, for example, by a fluid circulation. In an embodiment, water at the temperature of 5 to 30° C. is used for cooling.

The low temperature of the product P exiting the cooling also has the advantage that the wood composite product is as stiff as possible when it is discharged from the apparatus. By the terminal end of a cooling basin 4, the aim is to arrange the temperature of the product P low, to prevent distortion due to after-shrinkage of the product when it is cooled.

In an embodiment, additional plastic, which may be virgin or recycled plastic, is admixed with adhesive label laminate waste. According to the invention, it is possible to make wood composite material with or without additional plastic. In a patio plank, for example, the total content of additional plastic may be 0 to 90%, advantageously 0 to 50% and most preferably 10 to 30%. The total content of plastic in a patio plank may be 0 to 90%, advantageously 20 to 70% and most preferably 35 to 60%.

In an advantageous embodiment, additional plastic, for example polyolefin, polypropylene, polyethylene (HDPE, LDPE) or another suitable plastic, or a mixture of these, is added to adhesive label laminate waste to prepare the wood composite material. Moreover, other additives are added, if necessary, such as, for example, colouring agents, talc, adhesion promoters, fire retardants, anti-mould agents, and UV stabilizers.

For the production, it is possible to use various pretreatments, by which various raw materials can be combined before the extrusion. In an embodiment, the adhesive label laminate waste and the additional plastic are introduced as a combined flow into the manufacture of the wood composite material. In another embodiment, the adhesive label laminate waste and the additional plastic are introduced as separate flows into the manufacture of the wood composite material. The adhesive label laminate waste and the additional plastic can be advantageously mixed into a homogeneous mixture before the manufacture of the wood composite product. Alternatively, the additional plastic is led into the adhesive label laminate waste in connection with the manufacture of the wood composite material.

In an advantageous embodiment, the share of the adhesive label laminate waste in the wood composite material is substantially greater than 50%.

For the manufacture of the wood composite, it is possible to use finished adhesive label laminate products or waste material generated from them or during their manufacture. Furthermore, it is possible to use reject from production and recycled material from further processing and end use. In an embodiment, the adhesive label laminate waste originates from adhesive label laminate production, from which primarily production reject waste, edge cuttings from rolls and roll ends are produced; from adhesive label laminate printing stations, from which primarily roll ends and label material left over from the die cutting of stickers and labels as well as reject are produced; and/or from the end user clients of the adhesive label laminate, who paste the printed stickers and labels or the like onto their products. The waste coming from the end users is primarily release material, roll ends, and waste from the finished product.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention may be freely varied within the scope of the inventive features presented in the claims hereinbelow.

1. A method for forming a wood composite product by extrusion by a manufacturing apparatus that comprises an extruder, a die, and a calibration device, the method comprising:
making a surface of the wood composite product rough, wherein making the surface of the wood rough comprises adjusting a temperature profile of the manufacturing apparatus such that a temperature is higher at an initial end of the extruder than at a terminal end of the extruder, and the temperature is higher in the die than at the terminal end of the extruder.

2. The method according to claim 1, wherein the temperature profile prevailing in the manufacturing apparatus is adjusted such that the temperature of the material to be fed into the die is 165 to 185° C.

3. The method according to claim 1, wherein the manufacturing apparatus comprises an adapter that can be connected to the extruder, and wherein the temperature of the adapter is higher than the temperature at the terminal end of the extruder and lower than the temperature in the die.

4. The method according to claim 2, wherein the manufacturing apparatus comprises an adapter that can be connected to the extruder, and wherein the temperature of the material in the adapter is 165 to 185° C.

5. The method according to claim 2, wherein the temperature profile prevailing in the manufacturing apparatus is adjusted by dividing the extruder into at least two heating zones in a direction of a material flow so that the temperature at the initial end of the extruder is 200 to 235° C., and the temperature at the terminal end of the extruder is 140 to 150° C.

6. The method according to claim 4, wherein the extruder is divided into six heating zones in the direction of the material flow so that a temperature of a first heating zone is 225 to 235° C., a temperature of a second heating zone is 220 to 230° C., a temperature of a third heating zone is 210 to 220° C., a temperature of a fourth heating zone is 170 to 180° C., a temperature of a fifth heating zone is 140 to 150° C., and a temperature of a sixth heating zone is 165 to 175° C.

7. The method according to claim 2, wherein the temperature profile prevailing in the manufacturing apparatus is adjusted by dividing the die into at least two temperature zones in a direction of a material flow so that the temperature at an inlet of the die is 180 to 190° C., and the temperature at an outlet of the die is 195 to 205° C.

8. The method according to claim 1, wherein the material is driven through the extruder under the pressure of 8.5 to 9.5 MPa.

9. The method according to claim 1, wherein the product is formed of adhesive label laminate and polymer material.

10. The method according to claim 9, wherein the adhesive label laminate is shredded adhesive label laminate waste.

11. An extruded wood composite product with a rough surface manufactured according to claim 1.

12. The product according to claim 11, wherein a deviation of bulges and depressions on the surface is less than 1 mm from an average surface level.

13. The product according to claim 12, wherein the deviation is 10 to 700 μm.

14. The product according to claim 11, wherein the product comprises polymer material and adhesive label laminate waste formed of label material, an adhesive layer, and release material.

15. The product according to claim 14, wherein the label material and/or the release material comprise at least one component chosen from: a wood fiber based component, an organic component, and an inorganic component.

16. An apparatus for manufacturing a wood composite product, the apparatus comprising:
an extruder,
a die, and
a calibration device,
wherein the extruder and die comprise at least one heating device, wherein the at least one heating device is arranged to heat a composite material flowing in the manufacturing apparatus such that a temperature at an initial end of the extruder is higher than a temperature at a terminal end of the extruder, and a temperature in the die is higher than a temperature at the terminal end of the extruder, wherein a surface of the wood composite product to be formed becomes rough.

17. The apparatus according to claim 16, wherein the at least one heating device is arranged to heat the material to be fed into the die to a temperature from 165 to 185° C.

18. An apparatus according to claim 16, further comprising:
an adapter configured to be connected to the extruder, and comprising at least one heating device.

19. The apparatus according to claim 18, wherein the at least one heating device of the adapter is arranged to heat the adapter such that a temperature of the adapter is higher than the temperature at the terminal end of the extruder and lower than the temperature in the die.

20. The apparatus according to claim 16, wherein the extruder is divided into at least two heating zones in a direction of the material flow, and wherein the at least one heating device is arranged to heat the extruder such that the temperature at the initial end of the extruder is 200 to 235° C., and the temperature at the terminal end of the extruder is 140 to 150° C.

21. The apparatus according to claim 16, wherein the extruder is divided into six heating zones in a direction of the material flow, and wherein the at least one heating device is arranged to heat the extruder such that temperature of a first heating zone is 225 to 235° C., a temperature of a second heating zone is 220 to 230° C., a temperature of the third heating zone is 210 to 220° C., a temperature of a fourth heating zone is 170 to 180° C., a temperature of a fifth heating zone is 140 to 150° C., and a temperature of a sixth heating zone is 165 to 175° C.

22. The apparatus according to claim 16, wherein the at least one heating device is arranged to heat the die in the direction of the material flow such that the temperature at the inlet of the die is 180 to 190° C., and the temperature at the outlet of the die is 190 to 205° C.

23. An extruded wood composite product, comprising:
polymer material and adhesive label laminate waste comprising label material, an adhesive layer, and release material, wherein the label material and/or the release material comprise at least one of a wood fiber based component, an organic component, and an inorganic component,
wherein a surface of the product is rough, wherein the surface comprises a deviation of bulges and depressions on the surface, wherein the deviation is less than 1 mm from an average surface level.
